(19) United States
(12) Patent Application Publication
(10) Pub. No.: US 2020/0211121 A1
(43) Pub. Date: Jul. 2, 2020

(54) CREDIT-BASED CLAIM SETTLEMENT IMPLEMENTING METHOD AND DEVICE

(71) Applicant: ALIBABA GROUP HOLDING LIMITED, Grand Cayman (KY)

(72) Inventors: Yufeng GUO, HANGZHOU (CN); Bin WANG, HANGZHOU (CN); Yahui LIU, HANGZHOU (CN)

(21) Appl. No.: 16/806,781

(22) Filed: Mar. 2, 2020

Related U.S. Application Data
(63) Continuation of application No. PCT/CN2018/108926, filed on Sep. 30, 2018.

(30) Foreign Application Priority Data
Nov. 22, 2017 (CN) 201711172817.7

(51) Int. Cl. G06Q 40/08; G06Q 30/00; G06Q 40/02; G06N 20/00; G06N 5/04

(52) U.S. Cl. CPC G06Q 40/08; G06Q 30/018; G06N 5/04; G06N 20/00; G06Q 40/025

(57) ABSTRACT

A credit-based claim settlement implementing method comprises receiving a claim settlement request from a user terminal of a user. In response to receiving the claim settlement request, the method further comprises: determining credit information of the user; when the credit information of the user satisfies a credit constraint condition, prompting the user to upload images of claim settlement materials from the user terminal; detecting, using a living body detection technology, whether uploading the images of claim settlement materials is performed by uploading a photograph taken in real time from the user terminal; in response to detecting that uploading the images of claim settlement materials is performed by uploading a photograph taken in real time from the user terminal, determining whether the claim settlement materials are authentic; and in response to determining that the claim settlement materials are authentic, determining a claim settlement amount based on the claim settlement materials.

### CROSS-REFERENCE TO RELATED APPLICATIONS

This is a continuation of International Patent Application No. PCT/CN2018/108926, filed on Sep. 30, 2018, and entitled “CREDIT-BASED CLAIM SETTLEMENT IMPLEMENTING METHOD AND DEVICE”, which is based on and claims priority to and benefit of Chinese Patent Application No. 201711172817.7, filed with China National Intellectual Property Administration (CNIPA) of People's Republic of China on Nov. 22, 2017, and entitled “CREDIT-BASED CLAIM SETTLEMENT IMPLEMENTING METHOD AND APPARATUS”. The entire disclosures of all of the above-identified applications are incorporated herein by reference.

### TECHNICAL FIELD

The present specification relates to the field of Internet technology, and in particular, to a credit-based claim settlement implementing method and an apparatus/device thereof.

### BACKGROUND

In recent years, with the improvement of human living standards, the insurance industry develops rapidly, bringing challenges to claim settlement procedures. At present, various claim settlement processes are quite cumbersome, which require the applicants to provide a large amount of materials, followed by a manual verification on those materials, such as verifying whether the material is falsified. The process leads to low claim settlement efficiency and poor claim settlement experiences.

### SUMMARY

The present specification discloses a credit-based claim settlement implementing method and an apparatus/device thereof. The embodiments of the present specification may be implemented by the following technical solutions.

A credit-based claim settlement implementing method may comprise: receiving a claim settlement request from a user terminal of a user; in response to receiving the claim settlement request, determining credit information of the user; when the credit information of the user satisfies a credit constraint condition, prompting the user to upload images of claim settlement materials from the user terminal; detecting, using a living body detection technology, whether uploading the images of claim settlement materials is performed by uploading a photograph taken in real time from the user terminal; in response to detecting that uploading the images of claim settlement materials is performed by uploading a photograph taken in real time from the user terminal, determining whether the claim settlement materials are authentic; and in response to determining that the claim settlement materials are authentic, determining a claim settlement amount based on the claim settlement materials.

A credit-based claim settlement implementing device may comprise a processor and a memory storing machine-executable instructions. The instructions may be executed to cause the processor to perform operations including: receiving a claim settlement request from a user terminal of a user; in response to receiving the claim settlement request, determining credit information of the user; when the credit information of the user satisfies a credit constraint condition, prompting the user to upload images of claim settlement materials from the user terminal; detecting, using a living body detection technology, whether uploading the images of claim settlement materials is performed by uploading a photograph taken in real time from the user terminal; in response to detecting that uploading the images of claim settlement materials is performed by uploading a photograph taken in real time from the user terminal, determining whether the claim settlement materials are authentic; and in response to determining that the claim settlement materials are authentic, determining a claim settlement amount based on the claim settlement materials.

A non-transitory computer-readable storage medium may comprise computer instructions stored in a memory. The instructions may be executed by a processor to cause the processor to perform operations including: receiving a claim settlement request from a user terminal of a user; in response to receiving the claim settlement request, determining credit information of the user; when the credit information of the user satisfies a credit constraint condition, prompting the user to upload images of claim settlement materials from the user terminal; detecting, using a living body detection technology, whether uploading the images of claim settlement materials is performed by uploading a photograph taken in real time from the user terminal; in response to detecting that uploading the images of claim settlement materials is performed by uploading a photograph taken in real time from the user terminal, determining whether the claim settlement materials are authentic; and in response to determining that the claim settlement materials are authentic, determining a claim settlement amount based on the claim settlement materials.

In the present specification, when credit information of a user satisfies a credit constraint condition, the user is allowed to submit a claim online and upload claim settlement materials. If the claim settlement materials uploaded by the user are authenticated, the claim submitted by the user can be processed accordingly. The entire process does not need human intervention. On the one hand, claim settlement efficiency can be greatly enhanced, and claim settlement experience of the user can be improved. On the other hand, the credit-based claim settlement and smart online verification of the claim settlement materials can also protect interests of insurance companies and avoid financial losses caused by insurance fraud and other acts effectively.

### BRIEF DESCRIPTION OF THE DRAWINGS

FIG. 1 is a flow chart of a credit-based claim settlement implementing method according to an embodiment of the present specification.

FIG. 2 is a flow chart of a credit-based medical insurance claim settlement implementing method according to an embodiment of the present specification.

FIG. 3 is a structural diagram of an apparatus for implementing credit-based claim settlement according to an embodiment of the present specification.

FIG. 4 is a block diagram of a credit-based claim settlement implementing apparatus according to an embodiment of the present specification.

### DETAILED DESCRIPTION

The embodiments of the present specification are described in detail herein, which are illustrated in the accompanying drawings. In the following description of the accompanying drawings, the same numerals in different accompanying drawings represent the same or similar elements unless otherwise indicated. The implementation manners described in the following embodiments do not represent all implementation manners disclosed in the present specification. Conversely, they are merely examples of apparatuses and methods consistent with some aspects of the present specification, as detailed in attached claims.

Terms used in the present specification are only for describing specific embodiments rather than limiting the present specification. In the present specification and the attached claims, the singular forms “a”, “an”, and “the” may include the plural forms as well, unless the context clearly indicates otherwise. It should also be understood that the term “and/or” used herein refers to and includes any or all possible combinations of one or more associated listed items.

It should be understood that although terms such as first, second, and third may be used in the present specification to describe various information, and the information should not be limited to these terms. These terms are only used to distinguish one information from another information of the same type. For example, without departing from the scope of the present specification, first information may alternatively be referred to as second information, or vice versa, the second information may be referred to as the first information. Depending on the context, the word “if” used herein can be interpreted as “at the time of” or “when” or “in response to the determination”.

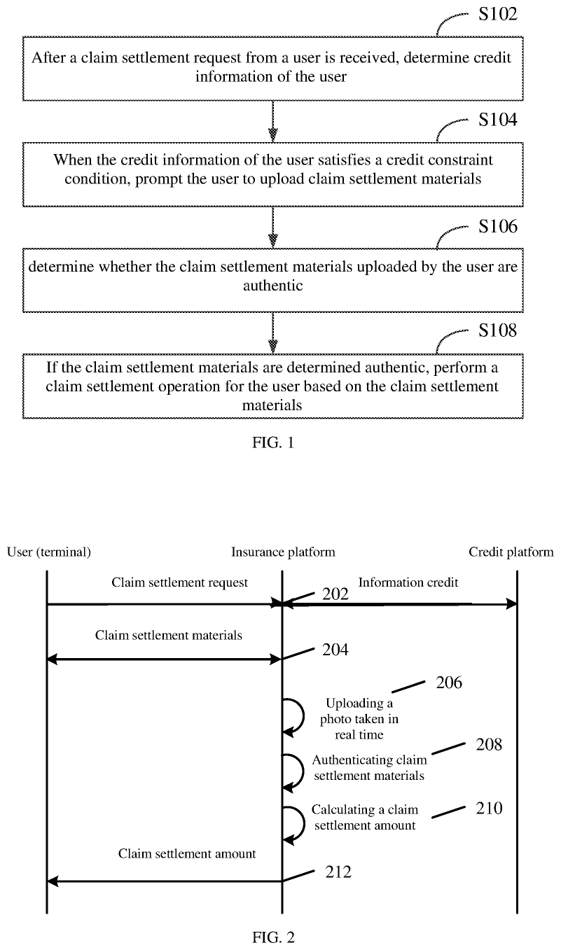

FIG. 1 is a flow chart of a credit-based claim settlement implementing method according to an embodiment of the present specification.

Referring to FIG. 1, the credit-based claim settlement implementing method may comprise the following steps.

In step 102, after a claim settlement request from a user is received, credit information of the user is determined.

The claim settlement request may be, but not limited to, a settlement request for a medical insurance claim, a settlement request for a mobile phone screen breakage insurance claim, a settlement request for a car insurance claim, or the like.

In step 104, when the credit information of the user satisfies a credit constraint condition, the user is prompted to upload claim settlement materials.

The claim settlement materials may be uploaded by the user who initiates the claim settlement request, and may include a photo of a payment invoice, a picture of an accident, or the like.

In step 106: it is determined whether the claim settlement materials uploaded by the user are authentic.

Whether the claim settlement materials are uploaded with uploading a photo taken in real time can be verified, and whether the claim settlement materials are authentic, for example, whether a payment invoice is authentic or falsified, can be further verified.

In step 108: if the claim settlement materials are determined authentic, a claim settlement operation is performed for the user based on the claim settlement materials.

If it is determined that the claim settlement materials are authentic, a corresponding claim settlement amount can be calculated according to the claim settlement materials, and then the claim settlement operation can be performed.

When the credit information of a user satisfies a credit constraint condition, the user may be allowed to submit a claim online and upload the claim settlement materials for authentication. When the claim settlement materials uploaded by the user pass the authentication, the claim settlement request submitted by the user can be processed. The entire process may not need any human intervention. On one hand, the claim settlement efficiency can be greatly enhanced, and the claim settlement experience of the user can be improved. On the other hand, the credit-based claim settlement and the smart online verification of the claim settlement materials can also protect interests of insurance companies and avoid financial losses caused by insurance fraud and other acts effectively.

In an embodiment of the present specification, the credit-based claim settlement implementing method may be applicable to a credit platform deployed by a credit service provider, wherein the credit platform may have a payment function, or can call other platforms that have a payment function to implement the payment operations.

The credit-based claim settlement implementing method may also be applicable to an insurance platform deployed by an insurance company, wherein the insurance platform may have a user credit assessment function or can call credit assessment functions of other third-parties to obtain the credit information of a user.

The credit-based claim settlement implementing method may also be implemented through a cooperation between a credit platform and an insurance platform. For example, the credit platform may provide a credit assessment function, and the insurance platform may provide functions of verifying the claim settlement materials and performing a claim settlement operation, which are not limited by the present specification.

Physical carriers of the above-described credit platform and insurance platform may include, but not limited to, servers or server clusters deployed by associated service providers.

The implementation of the embodiments of the present specification is described below using a claim settlement request for a medical insurance as an example.

Referring to FIG. 2, the credit-based medical insurance claim settlement implementing method may comprise the following steps.

In step 202, after an insurance platform receives a claim settlement request sent from a user, the insurance platform may obtain the credit information of the user from a credit platform.

Using a user initiating the claim settlement request through the insurance platform as an example, when initiating the claim settlement request, the user can select a claim settlement type, such as a claim settlement of a medical insurance.

In an embodiment of the present specification, if the user submits a claim for other insurance, the user may select other claim settlement types accordingly, such as a settlement of a car insurance claim or of a freight insurance claim, which is not limited by the present specification.

In an embodiment of the present specification, after receiving the above-described claim settlement request, the insurance platform can determine an identity of the user based on login information of the user, such as ID card number and name. The user may not need to re-enter the identity information.

After the claim settlement request is received, if the claim settlement type is a type having a higher claim settlement amount, an identity authentication may be performed on the user first. For example, the user may be required to take a photo of his/her face to determine whether such an operation is performed by the user. In another embodiment of the present specification, the identity authentication may be alternatively performed using other manners including, but not limited to, a mobile phone number verification or an address verification, which may be referred to verification solutions provided in related technologies.

The above-described claim settlement types requiring the identity authentication may be set up in advance. For example, for a claim settlement type having a higher claim settlement amount, such as a claim settlement of a medical insurance or a car insurance, the identity authentication may be set up. For a claim settlement type having a lower claim settlement amount, such as a claim settlement of a freight insurance, the identity authentication may be omitted. The credit information of the user can be obtained right after the claim settlement request is received, which is not limited by the present specification.

In an embodiment of the present specification, the insurance platform may obtain the credit information of the user from a credit platform through an interface provided by the credit platform.

The credit information may be presented as a credit score. Based on the credit score, a credit rating of the user, such as credit-eligible or credit-ineligible, can be directly determined. The credit-eligible usually indicates that the user has a better credit and a lower insurance fraud probability. The credit-ineligible, on the other hand, usually indicates that the user has a poorer credit and a higher insurance fraud probability.

The credit information may be presented as a credit score and a credit rating. The credit rating may include the credit-eligible and the credit-ineligible. Based on the credit rating, the credit information of the user can be directly determined accordingly. Additionally, based on the credit scores, users with the same credit rating can be further distinguished from others.

The credit information may be determined by the credit platform after the credit platform is called by the insurance platform. In another embodiment of the present specification, the credit information may be predetermined and stored by the credit platform. When the insurance platform calls for the credit information of the user, the stored credit information may be returned to the insurance platform.

The credit platform may determine the credit information of the user according to information such as asset information, claim settlement frequencies, or a credit history of the user. For example, the information including the asset information, the claim settlement frequencies, or the credit history of the user can be converted into numerical values, and the credit score of the user can be determined through manners including weighted averaging or the like.

The credit score of the user may be alternatively determined by other manners, which are not limited by the present specification.

In step 204, when the credit information satisfies a credit constraint condition, the insurance platform may prompt the user to upload claim settlement materials.

In the above-described step 202, after obtaining the credit information of the user, the insurance platform may determine whether the credit information meets a credit constraint condition, for example, determining whether the credit score of the user is greater than a score threshold.

The credit constraint condition may be preset by the insurance platform. For different claim settlement types, corresponding credit constraint conditions can be the same or different.

In an embodiment of the present specification, the process of determining whether the credit information satisfies a credit constraint condition may be alternatively implemented by a credit system. For example, the credit constraint condition may be preconfigured in the credit system. The credit system may determine whether the credit information satisfies a credit constraint condition after obtaining the credit information of the user, and return a determination result to the insurance platform, which is not limited by the present specification.

If the credit information of the user satisfies a credit constraint condition, the insurance platform may prompt the user to upload the claim settlement materials. For example, the insurance platform may send to the client software used by the user a message for uploading the claim settlement materials. When the user confirms the message, the client software can call a camera for acquiring image. The processing and implementation of this step may be referred to the related technologies, which are not be elaborated in the present specification.

Different claim settlement types may correspond to different claim settlement materials.

The claim settlement materials corresponding to a settlement of a medical insurance claim may include a payment invoice, proofs of medical records, and the like. The claim settlement materials for a settlement of a car insurance claim may include photos of the damages, a repair invoice, and the like. The claim settlement materials for a settlement of a mobile phone screen breakage insurance claim may include a photo of the mobile phone with a broken screen. The claim settlement materials can be determined by the insurance platform and be uploaded by the user according to the determination.

In step 206, the insurance platform detects, using a living body detection technology, whether uploading the claim settlement materials is performed by uploading photos taken in real time, i.e., at the time of uploading the photos.

In order to prevent the user from falsifying the claim settlement materials using an image processing technology for illegally obtaining the compensation or the like, the insurance platform may detect, using a living body detection technology, whether uploading the claim settlement materials is performed by uploading photos taken in real time.

For example, after a camera is called, the user may be prompted to shake the claim settlement materials, to prove that the claim settlement materials are indeed in the hands of the user.

The above-described living body detection process may be implemented by the insurance platform or a client terminal connected with the insurance platform, which is not limited by the present specification.

If it is determined that uploading the claim settlement material is performed by uploading a photo taken in real time, Step 206 may be performed.

If it is determined that uploading the claim settlement material is not performed by uploading a photo taken in real time, a prompt message may be output to the user to prompt the user to upload the claim settlement materials again.

Step 208: if uploading the claim settlement material is performed by uploading a photo taken in real time, the insurance platform may authenticate the claim settlement materials.

Based on a determination result in the above-described step 206, when uploading the claim settlement material is performed by uploading a photo taken in real time, it can be determined that the claim settlement materials are indeed in the hands of the user, and the user does not use a photo to obtain insurance compensation illegally.

In this embodiment of the present specification, the claim settlement materials can be further authenticated.

For example, when the claim settlement materials including a payment invoice, an AI (Artificial Intelligence) technology may be used to identify the invoice information of the payment invoice, such as an invoice number, an invoice header, or a name of a payer.

Based on the identified invoice information, the insurance platform can call an interface provided by a tax system to further authenticate the payment invoice.

If the payment invoice is determined to be authentic, it can be determined that the payment invoice passes the authentication, and Step 210 may be performed.

If the payment invoice is determined to be falsified, it can be determined that the payment invoice does not pass the authentication. The user is suspected of insurance fraud, and the credit platform can be notified to negatively update the credit information of the user.

In another embodiment of the present specification, if the claim settlement materials include a proof of medical records, the AI technology may be used to identify whether the proof of medical records has a corresponding doctor's signature, or a hospital seal, etc. Identification can be made according to the requirements of proofs of real medical records.

In an embodiment of the present specification, in addition to the AI technology, other technologies may also be used to authenticate the claim settlement materials, which are not limited by the present specification.

In step 210, if the claim settlement material passes the authentication, the insurance platform may calculate a claim settlement amount corresponding to the claim settlement materials.

Based on the identification result in the above-described Step 208, if it is determined that the claim settlement materials pass the authentication, it can be determined that the claim settlement request is a real settlement request but not an insurance fraud.

The claim settlement amount corresponding to the claim settlement material can be calculated. For example, an OCR (Optical Character Recognition) technology may be used to identify a payment amount in the payment invoice, and the corresponding claim settlement amount may be calculated accordingly.

In an embodiment of the present specification, for a settlement of a medical insurance claim, categories (A, B, or C) and corresponding amounts of various expenses in the payment invoices can be identified based on the OCR technology. Then a corresponding claim settlement amount may be calculated based on the type of the medical insurance insured by the user.

In another embodiment of the present specification, if the claim settlement type is a settlement of a mobile phone screen breakage insurance claim, a degree of screen breakage can also be identified based on an image processing technology. Then a corresponding claim settlement amount may be calculated according to the degree of screen breakage, which is not be elaborated in the present specification.

In step 212, when the claim settlement amount does not exceed a self-service claim settlement amount limit, the insurance platform may perform a claim settlement operation for the user, such as compensating the user in the amount of the claim settlement amount.

Based on the above-described step 210, after calculating the claim settlement amount, the insurance platform can determine whether the claim settlement amount exceeds a self-service claim settlement amount limit. Here, the self-service claim settlement amount limit is usually set by an insurance company according to the claim settlement type.

When the claim settlement amount does not exceed the self-service claim settlement amount limit, the user can be compensated directly. For example, the fund in the claim settlement amount may be transferred to an account bound with the user.

When the claim settlement amount exceeds the self-service claim settlement amount limit, in order to protect the interests of the insurance company, the claim settlement request may be forwarded for manually processing, so that the personals of the insurance company may perform a further verification.

In an embodiment of the present specification, the above-described self-service claim settlement amount limit may not be set up, which is not limited by the present specification.

In an embodiment of the present specification, the insurance platform may further return a result of the claim settlement to the credit platform after processing the claim settlement request of the user, and the credit platform may update the credit information of the user accordingly.

For example, if the claim of the user is settled successfully, the credit platform may positively update the credit information of the user.

For another example, if the user is suspected of insurance fraud, the credit platform may negatively update the credit information of the user, and the user may be prohibited to submit an online claim afterwards.

In the embodiments of the present specification, the claim settlement can be implemented online, which provides ease of operation and high claim settlement efficiency to the user. For an insurance company, the credit-based claim settlement and smart online verification of the claim settlement materials can effectively protect the interests of the insurance company, effectively avoid financial losses caused by insurance fraud and other acts, and save a large amount of labor costs.

It should be noted that the information interaction among the user, the insurance platform, and the credit platform described in the present specification is a general information interaction among a terminal device used by the user or the client software installed on the terminal device, the insurance platform, and the credit platform.

In accordance with the above-described embodiments of the credit-based claim settlement implementing method, the embodiments of the present specification further provide a credit-based claim settlement implementing apparatus.

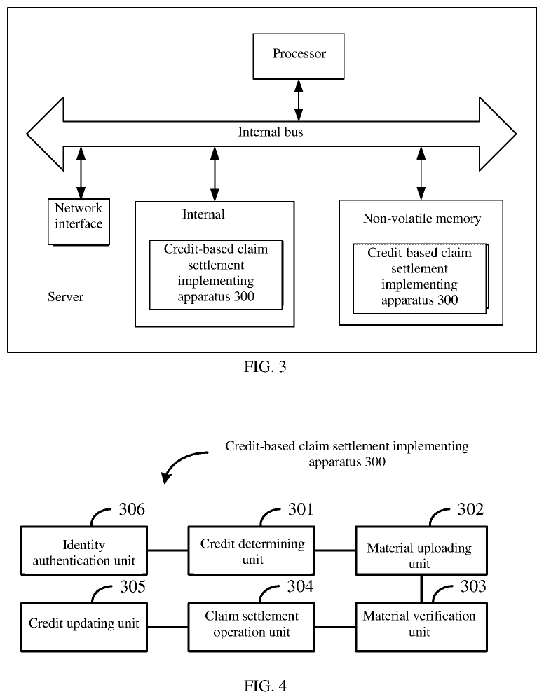

The credit-based claim settlement implementing apparatus in the embodiments of the present specification may be applicable to a server. The apparatus embodiments of the present specification may be achieved by software, hardware, or a combination of software and hardware. Using the software for achieving the embodiments as an example, the apparatus may be implemented by reading corresponding computer program instructions from a non-volatile memory into an internal storage and executing the instructions by processors of the server in which the apparatus is located. In terms of the hardware, FIG. 3 is a hardware structural diagram of a server in which the credit-based claim settlement implementing apparatus according to the present specification is located. In addition to the processors, the internal storage, the network interface, and the non-volatile memory shown in FIG. 3, the server in which the apparatus of this embodiment is located may further include other hardware according to actual functions of the server, which is not be elaborated herein.

FIG. 4 is a block diagram of a credit-based claim settlement implementing apparatus according to an embodiment of the present specification.

Referring to FIG. 4, the credit-based claim settlement implementing apparatus 300 may be applicable to the above-described server shown in FIG. 3, and comprise a credit determining unit 301, a material uploading unit 302, a material verification unit 303, a claim settlement operation unit 304, a credit updating unit 305, and an identity authentication unit 306.

The credit determining unit 301 may be configured to, after a claim settlement request sent from a user is received, determine credit information of the user.

The material uploading unit 302 may be configured to, when the credit information satisfies a credit constraint condition, prompt the user to upload claim settlement materials.

The material verification unit 303 may be configured to determine whether the claim settlement materials uploaded by the user are authentic.

The claim settlement operation unit 304 may be configured to, if the claim settlement materials are determined authentic, perform a claim settlement operation for the user on the basis of the claim settlement materials, such as initiating transfer of fund in a claim settlement amount to the user.

In an embodiment of the present specification, the material verification unit 303 may be further configured to: detect, using a living body detection technology, whether uploading the claim settlement materials is performed by uploading photos taken in real time; if uploading the claim settlement materials is performed by uploading photos taken in real time, authenticate the claim settlement materials; and if the claim settlement materials are authenticated, determine that the claim settlement materials pass the authentication.

When the claim settlement materials include a payment invoice, the material verification unit 303 may be further configured to identify invoice information of the payment invoice using an AI technology, and authenticate the payment invoice according to the invoice information.

The claim settlement operation unit 304 may be further configured to calculate a claim settlement amount corresponding to the claim settlement materials, and when the claim settlement amount does not exceed a self-service claim settlement amount limit, perform a claim settlement operation for the user based on the claim settlement amount, such as initiating transfer of fund in the claim settlement amount to the user.

The credit updating unit 305 may be configured to negatively update the credit information of the user if the claim settlement materials do not pass the authentication, such that the claim settlement materials are determined not authentic.

The identity authentication unit 306 may be configured to authenticate an identity of the user after the claim settlement request sent from the user is received. If the user passes the identity authentication, the credit determining unit 301 may be notified to determine the credit information of the user.

The credit determining unit 301 may be configured to determine the credit information of the user according to at least asset information, claim settlement frequencies, or a credit history of the user.

Details of the implementation of functions and effects of each unit in the above-described apparatus may be referred to the implementation of the corresponding steps in the above-described method, which are not be elaborated herein.

The apparatus embodiments basically correspond to the method embodiments, and may be referred to the corresponding description in the method embodiments. The above-described apparatus embodiments are only exemplary. Units described as separate components may or may not be physically separated, and the components shown as units may or may not be physical units. That is, the units or components may be located at one place or be distributed on multiple network units. Some or all of the units/modules may be selected according to actual needs to achieve the objectives of the solutions in the present specification. Those skilled in the art can understand and implement the solutions without creative efforts.

Systems, apparatuses, modules, or units described in the above-described embodiments may be implemented by computer chips or physical entities, or by products with certain functions. A typical implementation device may include a computer, and a specific form of the computer may be a personal computer, a laptop computer, a cellular phone, a camera phone, a smart phone, a personal digital assistant, a media player, a navigation device, an email sending and receiving device, a game console, a tablet computer, a wearable device, or a combination of any of these devices.

In accordance with the above-described embodiments of the credit-based claim settlement implementing method, the embodiments of the present specification further provide a credit-based claim settlement implementing apparatus. The credit-based claim settlement implementing apparatus may comprise a processor and a memory for storing machine-executable instructions. The processor and the memory are usually connected to each other through an internal bus. In other possible implementation manners, the apparatus may further include an external interface to enable communications with other devices or components.

The machine-executable instructions stored in the memory and corresponding to a credit-based claim settlement implementing method may be read and executed to cause the processor to perform the following operations: after a claim settlement request sent by a user is received, determining credit information of the user; when the credit information of the user satisfies a credit constraint condition, prompting the user to upload claim settlement materials; determining whether the claim settlement materials uploaded by the user are authentic; and if the claim settlement materials are determined authentic, performing a claim settlement operation for the user based on the claim settlement materials.

In an embodiment of the present specification, verifying the claim settlement materials uploaded by the user may further comprises: detecting, using a living body detection technology, whether the uploading the claim settlement materials is performed by uploading photos taken in real time; and if the uploading of the claim settlement materials is performed by uploading photos taken in real time, determining whether the claim settlement materials are authentic.

When the claim settlement materials include a payment invoice, determining whether the claim settlement materials are authentic comprises: identifying invoice information of the payment invoice using an AI technology; and determining whether the payment invoice is authentic according to the invoice information.

In an embodiment of the present specification, performing a claim settlement operation for the user based on the claim settlement materials may comprise: calculating a claim settlement amount corresponding to the claim settlement materials; and when the claim settlement amount does not exceed a self-service claim settlement amount limit, performing the claim settlement operation for the user based on the claim settlement amount, such as initiating transfer of fund in the claim settlement amount to the user.

In an embodiment of the present specification, the operations may further comprise negatively updating the credit information of the user if the claim settlement materials are determined not authentic.

After a claim settlement request sent from a user is received, the operations may further comprise authenticating an identity of the user, and determining the credit information of the user if the identity of the user is authenticated.

In an embodiment of the present specification, determining the credit information of the user may further comprise determining the credit information of the user according to at least asset information, claim settlement frequencies, or a credit history of the user.

In accordance with the above-described embodiments of the credit-based claim settlement implementing method, the embodiments of the present specification further provide a computer-readable storage medium. The computer-readable storage medium stores a computer program, which may be executed by a processor to perform the following operations: after a claim settlement request sent by a user is received, determining credit information of the user; when the credit information of the user satisfies a credit constraint condition, prompting the user to upload claim settlement materials; determining whether the claim settlement materials uploaded by the user are authentic; and if the claim settlement materials are determined authentic, performing a claim settlement operation for the user based on the claim settlement materials.

In an embodiment of the present specification, determining whether the claim settlement materials uploaded by the user are authentic may comprise: detecting, using a living body detection technology, whether uploading the claim settlement materials is performed by uploading photos taken in real time; and if uploading the claim settlement materials is performed by uploading photos taken in real time, determining whether the claim settlement materials are authentic.

When the claim settlement materials include a payment invoice, determining whether the claim settlement materials are authentic may comprise identifying invoice information of the payment invoice using an AI technology, and determining whether the payment invoice is authentic according to the invoice information.

In an embodiment of the present specification, performing a claim settlement operation for the user based on the claim settlement materials may comprise calculating a claim settlement amount corresponding to the claim settlement materials, and when the claim settlement amount does not exceed a self-service claim settlement amount limit, performing the claim settlement operation for the user based on the claim settlement amount, such as initiating transfer of fund in the claim settlement amount to the user.

In an embodiment of the present specification, the operations may further comprise negatively updating the credit information of the user if the claim settlement materials are determined not authentic.

After a claim settlement request sent from a user is received, the operations may further comprise authenticating an identity of the user, and determining the credit information of the user if the identity of the user is authenticated.

In an embodiment of the present specification, determining the credit information of the user may comprise determining the credit information of the user according to at least asset information, claim settlement frequencies, or a credit history of the user.

The specific embodiments of the present specification are described above. Other embodiments are also within the scope of the attached claims. In some cases, actions or steps in the claims may be performed in a sequence different from that in the embodiments, and the desired results still can be achieved. In addition, it is not necessary for the processes described in the accompanying drawings to be performed in the illustrated particular sequences or continuous sequences. In some implementation manners, multitasking and/or parallel processing may also be feasible or advantageous.

The above embodiments are only some preferred embodiments of the present specification and are not limited by the present specification. Any modification, equivalent replacement, or improvement made within the spirit and principles of the present specification shall fall within the protection scope of the present specification.

What is claimed is:

1. A credit-based claim settlement implementing method, comprising:
receiving a claim settlement request from a user terminal of a user;
in response to receiving the claim settlement request, determining credit information of the user;
when the credit information of the user satisfies a credit constraint condition, prompting the user to upload images of claim settlement materials from the user terminal;
detecting, using a living body detection technology, whether uploading the images of claim settlement materials is performed by uploading a photograph taken in real time from the user terminal;
in response to detecting that uploading the images of claim settlement materials is performed by uploading a photograph taken in real time from the user terminal, determining whether the claim settlement materials are authentic; and
in response to determining that the claim settlement materials are authentic, determining a claim settlement amount based on the claim settlement materials.

2. The method according to claim 1, wherein the determining credit information of the user comprises:
authenticating an identity of the user; and
in response to the identity of the user being authenticated, determining the credit information of the user.

3. The method according to claim 1, wherein when the claim settlement materials include a payment invoice, the determining whether the claim settlement materials are authentic comprises:
identifying invoice information of the payment invoice using an artificial intelligence technology; and
determining whether the payment invoice is authentic according to the invoice information.

4. The method according to claim 1, further comprising:
when the claim settlement amount does not exceed a self-service claim settlement limit, initiating transfer of fund in the claim settlement amount to the user.

5. The method according to claim 1, further comprising:
negatively updating the credit information of the user if the claim settlement materials are determined unauthentic.

6. The method according to claim 1, wherein the prompting the user to upload images of claim settlement materials from the user terminal comprises:
sending the user a message for uploading the images of claim settlement materials;
receiving a confirmation of the message from the user; and
acquiring the images of claim settlement materials obtained with a camera of the user terminal.

7. The method according to claim 1, wherein the determining credit information of the user comprises:
determining the credit information of the user according to at least asset information, claim settlement frequencies, or a credit history of the user.

8. A non-transitory computer-readable storage medium, comprising at least a computer instruction stored in a memory and executed by a processor, to cause the processor to perform operations comprising:
receiving a claim settlement request from a user terminal of a user;
in response to receiving the claim settlement request, determining credit information of the user;
when the credit information of the user satisfies a credit constraint condition, prompting the user to upload images of claim settlement materials from the user terminal;
detecting, using a living body detection technology, whether uploading the images of claim settlement materials is performed by uploading a photograph taken in real time from the user terminal;
in response to detecting that uploading the images of claim settlement materials is performed by uploading a photograph taken in real time from the user terminal, determining whether the claim settlement materials are authentic; and
in response to determining that the claim settlement materials are authentic, determining a claim settlement amount based on the claim settlement materials.

9. The non-transitory computer-readable storage medium according to claim 8, wherein the operations further comprise:
authenticating an identity of the user; and
in response to the identity of the user being authenticated, determining the credit information of the user.

10. The non-transitory computer-readable storage medium according to claim 9, wherein the operations further comprise:
when the claim settlement materials comprise a payment invoice,
identifying invoice information of the payment invoice using an artificial intelligence technology; and
determining whether the payment invoice is authentic according to the invoice information.

11. The non-transitory computer-readable storage medium according to claim 8, wherein the operations further comprise:
when the claim settlement amount does not exceed a self-service claim settlement limit, initiating transfer of fund in the claim settlement amount to the user.

12. The non-transitory computer-readable storage medium according to claim 8, wherein the operations further comprise:
negatively updating the credit information of the user if the claim settlement materials are determined unauthentic.

13. The non-transitory computer-readable storage medium according to claim 8, wherein the operations further comprise:
sending the user a message for uploading the images of claim settlement materials;
receiving a confirmation of the message from the user; and
acquiring the images of claim settlement materials obtained with a camera of the user terminal.

14. A credit-based claim settlement implementing device, comprising:
a processor; and
a memory storing machine-executable instructions, wherein the instructions are executable to cause the processor to perform operations including:
receiving a claim settlement request from a user terminal of a user;
in response to receiving the claim settlement request, determining credit information of the user;
when the credit information of the user satisfies a credit constraint condition, prompting the user to upload images of claim settlement materials from the user terminal;
detecting, using a living body detection technology, whether uploading the images of claim settlement materials is performed by uploading a photograph taken in real time from the user terminal;
in response to detecting that uploading the images of claim settlement materials is performed by uploading a photograph taken in real time from the user terminal, determining whether the claim settlement materials are authentic; and
in response to determining that the claim settlement materials are authentic, determining a claim settlement amount based on the claim settlement materials.

15. The apparatus according to claim 14, wherein the operations further comprise:
authenticating an identity of the user; and
in response to the identity of the user being authenticated, determining the credit information of the user.

16. The apparatus according to claim 15, wherein the operations further comprise:
when the claim settlement materials comprise a payment invoice,
identifying invoice information of the payment invoice using an artificial intelligence technology; and
determining whether the payment invoice is authentic according to the invoice information.

17. The apparatus according to claim 14, wherein the operations further comprise:
when the claim settlement amount does not exceed a self-service claim settlement limit, initiating transfer of fund in the claim settlement amount to the user.

18. The apparatus according to claim 14, wherein the operations further comprise:
negatively updating the credit information of the user if the claim settlement materials are determined unauthentic.

19. The apparatus according to claim 14, wherein the operations further comprise:
sending the user a message for uploading the images of claim settlement materials;
receiving a confirmation of the message from the user; and
acquiring the images of claim settlement materials obtained with a camera of the user terminal.

20. The apparatus according to claim 14, wherein the operations further comprise:
determining the credit information of the user according to at least asset information, claim settlement frequencies, or a credit history of the user.
